(19) United States
(12) Patent Application Publication
(10) Pub. No.: US 2023/0061372 A1
(43) Pub. Date: Mar. 2, 2023

(54) DEDUSTING DEVICE, SANDER AND METHOD FOR DEDUSTING A WORKPIECE

(71) Applicant: Karl Heesemann Maschinenfabrik GmbH & Co. KG, Bad Oeynhausen (DE)

(72) Inventor: Christoph GIESE, Bad Oeynhausen (DE)

(21) Appl. No.: 17/823,145

(22) Filed: Aug. 30, 2022

(30) Foreign Application Priority Data
Aug. 31, 2021 (EP) 21194059.8

(51) Int. Cl. B24B 55/08

(52) U.S. Cl. CPC B24B 55/08

(57) ABSTRACT

A dedusting device, such as for a sander, for dedusting particles from a narrow edge of a workpiece has a nozzle device designed to remove the particles from the edge with a blasting fluid. The nozzle device has at least one nozzle outlet opening through which the blasting fluid emerges for dedusting in a blasting region. An exhaust air device designed to extract by suction the particles removed from the narrow edge of the workpiece (has at least one exhaust air inlet opening through which a blasting fluid containing particles enters. A supporting device which, in the operating state, is used for the workpiece to bear against. The supporting device is arranged between the nozzle device and the exhaust air device.

### FIELD OF THE INVENTION

The invention relates to a dedusting device for dedusting a narrow edge of a workpiece of particles. The invention also relates to a sander and to a method for dedusting a workpiece with a dedusting device.

### BACKGROUND

If a workpiece is intended to be painted or coated with laminates or films, its surface has to meet particular requirements, for instance with regard to the surface roughness or surface cleanliness. Otherwise, paints or coatings do not stick to the surface of the workpiece at all or stick to said surface only insufficiently. In this regard, the desired requirements placed on the surface need to be realized by way of prior processing steps.

In particular in the case of a prior processing step such as sanding, however, it is difficult to achieve surfaces with the desired cleanliness. This is because the particles that arise during sanding tend to become electrostatically charged and so they stick to the surfaces of workpieces, in particular to the narrow edges thereof. The sanding particles tend in particular to stick in the region of the narrow edges and to the narrow edges themselves.

It is known to dedust workpieces by means of brushes. However, brushes are not very suitable for removing particles with a small size, for example less than 100 μm. Furthermore, brushes risk damaging the surface of workpieces when sensitive materials are used.

This can be avoided by contact-free cleaning of the surfaces. Various suction extraction devices for contact-free cleaning of surfaces are known from the prior art. For example DE 10 2017 117 715 A1, DE 35 17 677, EP 3 006 162 or CH 674 331. The known solutions have considerable drawbacks, however; particles can be removed from surfaces of workpieces, in particular from the narrow edges thereof—if at all—only with a high energy requirement. In particular, on account of the embodiment or arrangement of the known suction extraction devices, not all of the residual dust can be extracted by suction, in particular in the region of the narrow edges.

### SUMMARY

Therefore, the invention is based on the object of providing a dedusting device, a sander and a method for dedusting a workpiece with a dedusting device, which do not have the described drawbacks.

The dedusting device is in particular a dedusting device of a power tool. The power tool is preferably a sander, particularly preferably a wide-belt sander. The dedusting device is, in this regard, particularly suitable for dedusting workpieces that have been sanded or are intended to be sanded.

A workpiece has in particular one or more straight narrow edges. Furthermore, it may additionally or alternatively be preferred for the workpiece to have one or more convexly or concavely extending narrow edges. If the workpiece is circular, the narrow edge can extend annularly, in particular circularly around the workpiece. The narrow edge is in particular an end side or end face of the workpiece.

The workpiece generally always has at least one external narrow edge. Some workpieces can also have one or more internal narrow edges. Workpieces that have a cutout or a recess within the at least one external narrow edge generally have at least one internal narrow edge. A cutout is for example a through-opening from a first side of the workpiece to a second side opposite to the first side. A recess is for example a groove introduced into the workpiece.

A dedusting device extends in a longitudinal direction along a length and, orthogonally to the longitudinal direction, in a transverse direction across a width. Preferably, the longitudinal direction corresponds to a main processing direction of the power tool in the operating state. The length of the dedusting device in the longitudinal direction corresponds preferably to a length of a processing region of the power tool. The width of the dedusting device in the transverse direction corresponds preferably to a width of a processing region of the power tool.

The dedusting device has a nozzle device which is designed to remove the particles from the narrow edge of the workpiece with a blasting fluid. The nozzle device has at least one nozzle outlet opening through which the blasting fluid emerges from the nozzle device for dedusting in a blasting region. In particular, the nozzle device is arranged such that the at least one nozzle outlet opening is oriented towards the supporting device.

Preferably, when there are a plurality of nozzle outlet openings, the nozzle outlet openings are arranged in a row. Furthermore, it may be preferred that, when there are a plurality of nozzle outlet openings, the nozzle outlet openings are arranged in a manner distributed over an area. In particular, when there are a plurality of nozzle outlet openings, the nozzle outlet openings may form a carpet of nozzle outlet openings. Preferably, the nozzle outlet openings are arranged equidistantly from one another. Preferably, the nozzle outlet openings extend across a width of the dedusting device. Furthermore, it is additionally or alternatively preferred for the nozzle outlet openings to extend along a length of the dedusting device.

In particular, it may be preferred for the nozzle device with the nozzle outlet openings to be arranged so as to be displaceable along the length and/or across the width of the dedusting device relative to the supporting device. Furthermore, it may be preferred for the nozzle device with the nozzle outlet openings to be arranged so as to be pivotable with respect to the supporting device such that the nozzle device can blast the supporting device or a workpiece arranged on the supporting device in an operating state at an angle of between 0° and 90° or 90° and 180° with the blasting fluid. The pivotable arrangement of the nozzle device with the nozzle outlet openings with respect to the supporting device makes it possible in particular to pivot the blasting region about a pivot axis of the nozzle device. This allows better cleaning of a workpiece, in particular of the narrow edges of the workpiece, in the operating state.

In particular, the at least one nozzle outlet opening forms an outlet opening plane. Furthermore, it may be preferred for a first group of the at least one nozzle outlet opening to form a first outlet opening plane and for a second group of the at least one nozzle outlet opening to form a second outlet opening plane which is different from the first outlet opening plane. In particular, the outlet opening planes are formed in a planar manner. It may also be preferred for the first outlet opening plane to extend parallel to and at a distance from the second outlet opening plane.

Furthermore, the dedusting device has an exhaust air device which is designed to extract by suction the particles removed from the narrow edge of the workpiece. The exhaust air device has at least one exhaust air inlet opening through which a blasting fluid containing particles enters the exhaust air device for dedusting. In particular, the exhaust air inlet opening is fluidically connected to an exhaust air channel through which the particles removed from the narrow edge of the workpiece can be extracted by suction. In particular, the exhaust air device is arranged such that the at least one exhaust air inlet opening is oriented towards the supporting device.

In particular, the at least one exhaust air inlet opening forms an inlet opening plane. Furthermore, it may be preferred for a first group of the at least one exhaust air inlet opening to form a first inlet opening plane and for a second group of the at least one exhaust air inlet opening to form a second inlet opening plane which is different from the first inlet opening plane. In particular, the inlet opening planes are formed in a planar manner. It may furthermore be preferred for the first inlet opening plane to extend parallel to and at a distance from the second inlet opening plane.

Preferably, the exhaust air device and the nozzle device are arranged such that the at least one exhaust air inlet opening and the at least one nozzle outlet opening are oriented oppositely to one another at a distance from one another. Particularly preferably, the exhaust air device and the nozzle device are arranged such that the at least one exhaust air inlet opening and the at least one nozzle outlet opening are oriented so as to face one another.

In particular, the at least one exhaust air inlet opening is arranged downstream of the at least one nozzle outlet opening and at a distance therefrom in the direction of flow of the blasting fluid. In particular, the at least one nozzle outlet opening and at least one exhaust air inlet opening are arranged such that the outlet opening plane extends parallel to the inlet opening plane. Furthermore, it may be preferred for the first outlet opening plane to extend parallel to and at a distance from the first inlet opening plane. Additionally or alternatively, it may be preferred for the second outlet opening plane to extend parallel to and at a distance from the second inlet opening plane.

Furthermore, in one embodiment it may be preferred for the outlet opening plane and the inlet opening plane to be arranged at an acute angle to one another. Furthermore, it may be preferred for the first outlet opening plane to extend at an acute angle to the first inlet opening plane. Additionally or alternatively, it may be preferred for the second outlet opening plane to extend at an acute angle to the second inlet opening plane.

Furthermore, the dedusting device has a supporting device on which the workpiece to be dedusted bears in the operating state. In order to fix the workpiece to the supporting device in the operating state, the supporting device preferably has a suction face and a suction-extraction face. In the operating state, the workpieces to be processed and to be dedusted generally bear flat on the supporting device. In particular, in the operating state, the workpiece to be processed and to be dedusted can bear on the supporting device from above or can bear on the supporting device from below. The narrow edges of the workpiece are in this case in particular its end faces. In particular, in the operating state, the narrow edges extend substantially orthogonally to the supporting device, in particular to the suction face.

The supporting device extends between the suction face for workpieces and the suction-extraction face orthogonally to a main processing direction. Preferably, the suction face and the suction-extraction face of the supporting device extend in one plane. The suction-extraction face and the suction face are preferably arranged at a distance from one another. In particular, the suction-extraction face and the suction face extend parallel to one another.

The suction face extends preferably parallel to the outlet opening plane. In particular, the suction face extends parallel to the first and/or second outlet opening plane. Furthermore, it is preferred for the suction face to extend at an acute angle to the first and/or second outlet opening plane. The suction face extends preferably parallel to the inlet opening plane. In particular, the suction face extends parallel to the first and/or second inlet opening plane. Furthermore, it is preferred for the suction face to extend at an acute angle to the first and/or second inlet opening plane.

The suction-extraction face extends preferably parallel to the outlet opening plane. In particular, the suction-extraction face extends parallel to the first and/or second outlet opening plane. Furthermore, it is preferred for the suction-extraction face to extend at an acute angle to the first and/or second outlet opening plane. The suction-extraction face extends preferably parallel to the inlet opening plane. In particular, the suction-extraction face extends parallel to the first and/or second inlet opening plane. Furthermore, it is preferred for the suction-extraction face to extend at an acute angle to the first and/or second inlet opening plane.

In particular, the dedusting device may have at least one negative-pressure chamber, which is formed starting from the suction-extraction face of the supporting device. In particular, the negative-pressure chamber is arranged on the supporting device. Preferably, the negative-pressure chamber is arranged on the suction-extraction face of the supporting device. Preferably, the suction-extraction face of the supporting device forms an inner wall of the negative-pressure chamber.

The at least one negative-pressure chamber has in particular a lower pressure than an environment of the dedusting device. The environmental pressure can vary depending on the weather. A negative pressure within the negative-pressure chamber is generated preferably by a suction device.

It is provided that the supporting device is arranged between the nozzle device and the exhaust air device.

This arrangement allows virtually dust-free provision of processed workpieces, in particular sanded workpieces, for subsequently upcoming painting or coating. In particular the combination of the blasting fluid blasted with positive pressure out of the nozzle device and the blasting fluid containing particles extracted with negative pressure using the suction-extraction device brings about a better cleaning action of the dedusting device. Furthermore, the narrow edges of workpieces can be blasted in a targeted manner by the nozzle device. The suction-extraction device allows in particular targeted extraction by suction from the narrow edges.

According to a preferred development of the dedusting device, it is provided that, in the operating state, the exhaust air device is arranged above the supporting device and the nozzle device is arranged beneath the supporting device. Alternatively, it is provided that, in the operating state, the exhaust air device is arranged beneath the supporting device and the nozzle device is arranged above the supporting device.

According to a further preferred development, the supporting device is designed for fastening and/or conveying the workpiece to be dedusted. Preferably, the supporting device has a stationary table unit. Additionally or alternatively, the supporting device has a transport unit. This is designed to transport the workpiece to be processed in a main processing direction. To this end, the transport unit is preferably arranged so as to be movable relative to the table unit. Preferably, the transport unit is in the form of a transport carpet and/or transport belt and/or has conveyor rollers for transporting the workpiece.

In a further preferred embodiment, the dedusting device has an ionizing device for ionizing the blasting fluid. The ionizing device is preferably fluidically connected to the nozzle device. Preferably, the ionizing device is arranged upstream of the nozzle device in the direction of flow of the blasting fluid. In particular, the ionizing device is connected to a blasting fluid source, for example a compressed air network or a compressed air source.

The ionization of the blasting fluid allows an even further improved possible way of detaching particles adhering to workpieces, in particular particles adhering to narrow edges of the workpiece. The blasting of the workpieces, in particular the narrow edges of the workpiece, with an ionized blasting fluid improves the cleaning action of the dedusting device even further.

Furthermore according to a preferred embodiment, it is provided that the blasting fluid is compressed air and/or is an ionized blasting fluid and/or is a mixture of a gas, in particular compressed air, and an inert liquid.

The provision of the blasting fluid in the form of compressed air allows in particular quick, easy and cost-effective start-up and operation of the dedusting device. The provision of the blasting fluid in the form of a mixture preferably allows the provision of a blasting fluid adapted for the material of the workpiece, the geometric nature of the workpiece and the property of the particles.

Furthermore, one development preferably provides a dedusting device having an ultrasonic device. In this case, the ultrasonic device is designed to generate an ultrasonic exciter signal to detach the particles from the narrow edge. Preferably, the ultrasonic device is designed to generate the ultrasonic exciter signal with a frequency of at least 16 kHz and/or at most 10 GHz. In particular, the ultrasonic device is preferably designed to excite the blasting fluid.

As a result of the use of the ultrasonic device, particles adhering to workpieces, in particular particles adhering to narrow edges of the workpiece, can be detached even better. The blasting of the workpieces, in particular of the narrow edges of the workpieces, with a blasting fluid excited by an ultrasonic exciter signal improves the cleaning action of the dedusting device even further.

According to an even more preferred embodiment, the dedusting device has a workpiece detection device. The workpiece detection device is designed to sense a length and/or width and/or thickness of a workpiece. Additionally or alternatively, the workpiece detection device is designed to sense a position and/or location of the workpiece on the supporting device. Furthermore, the workpiece detection device is additionally or alternatively designed to sense at least one narrow edge of the workpiece, in particular a position and/or location of the at least one narrow edge.

Furthermore, according to one development, it is provided that the nozzle device has at least one first nozzle unit and/or at least one second nozzle unit. The at least one first nozzle unit and/or the at least one second nozzle unit each have at least one nozzle outlet opening. In particular, the at least one first nozzle unit and/or the at least one second nozzle unit have a plurality of nozzle outlet openings arranged in a row. Preferably, the nozzle outlet openings are arranged in one row. It may also be preferred for the nozzle outlet openings to be arranged in two or more rows.

Preferably, the at least first nozzle unit extends parallel to the main processing direction. Additionally or alternatively, the at least second nozzle unit extends preferably orthogonally to the main processing direction.

Preferably, the at least first and/or second nozzle unit is arrow-shaped, circular, semicircular and/or half-open.

Preferably, the at least first and/or the at least second nozzle unit is detachable, in particular arranged detachably on the supporting device.

By means of the at least first and/or second nozzle unit, the nozzle device can be adapted to the size, geometric shape, position and/or location of workpieces and/or to the number of workpieces that are to be dedusted. As a result, improved dedusting results can be achieved, in particular at the narrow edges of workpieces.

Furthermore, for a preferred embodiment, it is provided that the at least first and/or second nozzle unit is arranged so as to be displaceable relative to the supporting device. Preferably, the at least first and/or second nozzle unit is displaceable depending on the length and/or width and/or thickness and/or position and/or location, sensed by the workpiece detection device, of the workpiece. Additionally or alternatively, the at least first and/or second nozzle unit is preferably displaceable depending on the at least one narrow edge, sensed by the workpiece detection device, of the workpiece, in particular the position and/or location of the at least one narrow edge of the workpiece.

In particular, the at least first and/or second nozzle unit is arranged so as to be displaceable in translation with respect to the supporting device. Preferably, the at least first and/or second nozzle unit is displaceable in translation in a longitudinal direction and/or transverse direction and, orthogonally to the longitudinal direction and/or transverse direction, in a vertical direction. It may furthermore be preferred for the at least first and/or second nozzle unit to be arranged so as to be displaceable in rotation with respect to the supporting device. In particular, provision can be made for the at least first and/or second nozzle unit to be arranged so as to be displaceable in rotation with respect to the longitudinal direction and/or transverse direction and/or vertical direction. In particular, the at least first and/or second nozzle unit is arranged so as to be pivotable with respect to the supporting device. It may be preferred for the at least first and/or second nozzle unit to be arranged so as to be pivotable about a pivot axis parallel to the supporting device, in particular the suction face, and/or about a pivot axis orthogonal to the supporting device, in particular the suction face.

By means of the at least first and/or second nozzle unit, the nozzle device can be adapted to the size, geometric shape, position and location of workpieces and to the number of workpieces that are to be dedusted. This allows improved dedusting results, in particular at the narrow edges of the workpieces.

Furthermore, according to a preferred development of the dedusting device, the at least one first nozzle unit and/or the at least one second nozzle unit has at least one nozzle element. Preferably, a nozzle element has one nozzle outlet opening. It may be preferred for a nozzle element to have a plurality of nozzle outlet openings.

Preferably, one nozzle element or a plurality of nozzle elements of the at least one nozzle element is/are comprised by the first and second nozzle unit. In particular, the at least one first nozzle unit and/or the at least one second nozzle unit have a plurality of nozzle element arranged in a row. Preferably, the nozzle elements are arranged in one row. It may also be preferred for the nozzle elements to be arranged in two or more rows.

In particular, it may be preferred for at least one nozzle element to be arranged so as to be displaceable with respect to the supporting device. In particular, at least one nozzle element can be arranged so as to be displaceable in translation and/or rotation with respect to the supporting device.

By means of nozzle elements formed and/or arranged in such a way, the nozzle device can be adapted to the size, geometric shape, position and location of workpieces and to the number of workpieces that are to be dedusted. This allows improved dedusting results, in particular at the narrow edges of the workpieces.

According to a further development, the nozzle device, in particular the at least one first nozzle unit and/or the at least one second nozzle unit, is preferably arranged in such a way with respect to the supporting device that the blasting fluid emerges from the at least one nozzle outlet opening substantially perpendicularly to the supporting device.

Additionally or alternatively, in a further preferred development, the at least one first nozzle unit and/or the at least one second nozzle unit is arranged in such a way with respect to the supporting device that the blasting fluid emerges from the at least one nozzle outlet opening at an angle of between 0° and 90° or 90° and 180° to the supporting device.

Furthermore, according to a preferred embodiment, it is provided that the nozzle device has a pressure chamber which is arranged preferably on the supporting device, in particular on the table unit. Additionally or alternatively, the nozzle device has a valve device with at least one valve unit which fluidically connects the pressure chamber to the at least one first and/or second nozzle unit. In particular, the pressure chamber is fluidically connected to a blasting fluid source. Preferably, the ionizing device is fluidically arranged between the pressure chamber and the blasting fluid source.

By way of the pressure chamber, a relatively large quantity of the pressurized blasting fluid for blasting the workpiece, in particular the narrow edges, can advantageously be provided briefly through the nozzle outlet opening.

According to a further preferred embodiment, the supporting device, in particular the table unit and/or the transport unit, has a bearing channel profile with a plurality of bearing channels, wherein the bearing channel profile is designed such that at least half of the nozzle elements of the at least first and/or the at least second nozzle unit of the nozzle device are fluidically connected simultaneously to the bearing channels.

Preferably, the bearing channel profile is in the form of a hole profile. A hole profile can in particular have channels with a circular cross section, a polygonal cross section, preferably a square or rectangular cross section. Furthermore, it may be preferred for the bearing channel profile to be in the form of a slot profile. Preferably, the channels of the bearing channel profile are equidistant from one another. It may be preferred for channels to be arranged, at least partially, at a varying distance from one another.

According to a further preferred development, the dedusting device has a nozzle control device which is connected in signalling terms to the nozzle device and/or the workpiece detection device. In particular, the nozzle control device is designed to operate the nozzle device in pulsed operation and/or constant operation.

Additionally or alternatively, it may preferably also be provided, depending on the sensed length and/or the width and/or the thickness and/or the position of the workpiece, in particular depending on the sensed position and location of the sensed narrow edge, to actuate the nozzle device for pulsed operation and/or constant operation, in particular to activate individual nozzle elements for removing the particles from the narrow edge of the workpiece and/or to actuate the nozzle device, in particular the at least first and/or second nozzle unit, such that it is displaced relative to the supporting device.

This allows automated operation of the dedusting device in a particularly preferred manner.

Finally, in a further preferred development, it is provided that the exhaust air device has a particle charging device which is designed to electrically charge the particles removed from the blasted narrow edge of the workpiece. Preferably, the particle charging device electrically charges particles in accordance with the principle of static charging and/or diffusion charging and/or field charging. As a result, the particles extracted by suction can be removed from the blasting fluid.

Additionally or alternatively, it can preferably be provided that the exhaust air device has a vibration exciter device which is designed to detach the particles removed from the blasted narrow edge of the workpiece and then charged particles. By means of the vibration exciter device, the particles removed from the blasting fluid can be separated for disposal.

According to a further aspect, the object is achieved by a sander according to Claim 16.

The sander is preferably a wide-belt sander. The sander comprises a dedusting device. The dedusting device comprises individual features or a combination of features of the above-described dedusting device and the advantages and technical effects associated with the features.

According to a preferred embodiment of the sander, it has at least one sanding unit for processing a workpiece.

According to a further aspect, the object is achieved by a method for dedusting a workpiece with a dedusting device according to Claim 18. In particular, the object is achieved by a method for dedusting a workpiece with a dedusting device which comprises individual features or a combination of features of the above-described dedusting device and the advantages and technical effects associated with the features.

The method for dedusting the workpiece with the dedusting device comprises the following steps:
sensing a narrow edge of a workpiece to be dedusted; and
blasting the sensed narrow edge with a blasting fluid to remove particles from the sensed narrow edge.

According to a preferred embodiment of the method, it is provided that the step of sensing a narrow edge of a workpiece to be dedusted comprises the following sub-steps:
sensing a length and/or a width and/or a thickness and/or a position of the workpiece; and/or
sensing a position and/or location of the narrow edge of the workpiece; and/or
classifying the sensed narrow edge as a front edge and/or rear edge and/or side edge, in particular as an internal and/or external front edge and/or as an internal and/or external rear edge and/or as an internal and/or external side edge; and/or
classifying the sensed narrow edge as a straight edge and/or curved, in particular concavely extending and/or convexly extending narrow edge.

Additionally or alternatively, it is preferably provided that the step of blasting the sensed narrow edge with a blasting fluid to remove particles from the sensed narrow edge comprises the following sub-steps:
blasting the sensed narrow edge with the blasting fluid constantly if the sensed narrow edge has been classified as a side edge, in particular as an internal and/or external side edge; and/or
blasting the sensed narrow edge with the blasting fluid in a pulsed manner or constantly if the sensed narrow edge has been classified as a front edge and/or rear edge, in particular as an internal and/or external front edge and/or as an internal and/or external rear edge; and/or
blasting the sensed narrow edge with the blasting fluid in a pulsed manner or constantly if the sensed narrow edge is concave and/or convex and/or straight and/or circular.

Preferably, it is additionally or alternatively also provided that the method also comprises the following steps:
ionizing the blasting fluid; and/or
exciting the particle to be removed by absorption of an ultrasonic exciter signal from an ultrasonic device; and/or
   activating nozzle elements to remove the particles from the narrow edges depending on
   the sensed length and/or width and/or thickness and/or position of the workpiece; and/or
   the sensed position and/or location of the sensed narrow edge.

It should be understood that the dedusting device according to the one aspect of the invention, and the sander and the method for dedusting a workpiece with a dedusting device according to the further aspects of the invention have the same and similar sub-aspects and advantages, as is set out in particular in the dependent claims. In this regard, reference is made to the above description in its entirety.

Embodiments of the invention will now be described in the following text with reference to the drawings. These are intended to illustrate the embodiments not necessarily to scale; rather, the drawings, where useful for explanation, are provided in a schematic and/or slightly distorted form. For additions to the teachings that are immediately apparent from the drawings, reference is made to the relevant prior art. It should be taken into account here that many modifications and alterations relating to the form and detail of an embodiment may be undertaken without departing from the general concept of the invention. The features of the invention that are disclosed in the description, in the drawings and in the claims may be essential to the development of the invention on their own and in any combination. Moreover, all combinations of at least two of the features disclosed in the description, the drawings and/or the claims fall within the scope of the invention. The general concept of the invention is not limited to the exact form or the detail of the preferred embodiments shown and described in the following text or limited to subject matter that would be restricted compared with the subject matter claimed in the claims. For the sake of simplicity, the same reference signs are used in the following text for identical or similar parts or parts having an identical or similar function.

### DESCRIPTION OF THE DRAWINGS

Preferred embodiments of the invention are explained by way of example with reference to the accompanying figures.

FIG. 1 shows an isometric view of a preferred embodiment of a dedusting device;

FIG. 2 shows a sectional view of the dedusting device illustrated in FIG. 1;

FIG. 3 shows an isometric view of a preferred embodiment of a nozzle device as is also provided in the dedusting device illustrated in FIGS. 1 and 2;

FIG. 4 shows a detail view of the embodiment of the nozzle device illustrated in FIG. 3; and

FIG. 5 shows a schematic flow diagram of a preferred embodiment of a method for dedusting a workpiece with a dedusting device.

### DETAILED DESCRIPTION

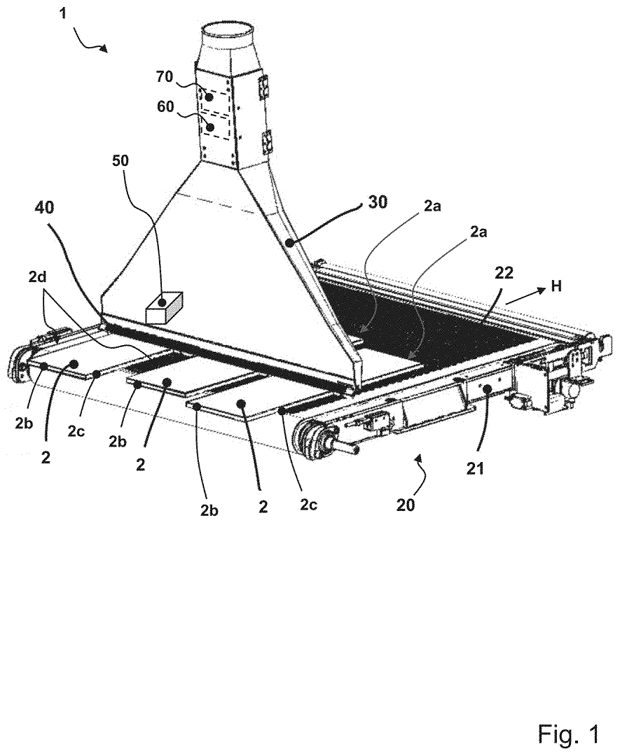

FIG. 1 shows an isometric view of a preferred embodiment of a dedusting device 1 of a sander. The dedusting device 1 is designed to dedust a narrow edge 2a, 2b, 2c, 2d of a workpiece 2 of particles. The dedusting device 1 illustrated in FIG. 1 has a nozzle device 10 (not visible in FIG. 1), an exhaust air device 30 and a supporting device 20.

The nozzle device 10 is designed to remove the particles from the narrow edge 2a, 2b, 2c, 2d of the workpiece 2 with a blasting fluid 3. To this end, the nozzle device 10 has at least one nozzle outlet opening 11, through which the blasting fluid 3 emerges from the nozzle device 10 for dedusting in a blasting region 140. FIG. 1 shows the dedusting device 1 in an operating state in which the exhaust air device 30 is arranged above the supporting device 20 and the nozzle device 10 is arranged beneath the supporting device 20. In an alternative preferred embodiment of the dedusting device 1, it may be preferred for the exhaust air device 30 to be arranged beneath the supporting device 20 in the operating state and the nozzle device 10 to be arranged above the supporting device 20.

The exhaust air device 30 is designed to extract by suction the particles removed from the narrow edge 2a, 2b, 2c, 2d of the workpiece 2. To this end, the exhaust air device 30 has at least one exhaust air inlet opening 31 through which a blasting fluid 3 containing particles enters the exhaust air device 30 for dedusting. To separate the particles removed from the narrow edges 2a, 2b, 2c, 2d from the blasting fluid 3 containing particles, it is provided that a particle charging device 60 and a vibration exciter device 70 are arranged within the exhaust air device 30. The particle charging device 60 is designed to electrically charge the particles removed from the blasted narrow edge 2a, 2b, 2c, 2d of the workpiece 2 such that the electrically charged particles stick within the exhaust air device 30. The particle charging device 60 can electrically charge the particles for example in accordance with the principle of static charging, diffusion charging or field charging. The vibration exciter device 70 is designed to accordingly detach the particles removed from the blasted narrow edge 2a, 2b, 2c, 2d of the workpiece 2 and then the charged particles for separation.

In the operating state, the workpiece 2 to be dedusted rests on the supporting device 20. The supporting device 20 is in this case designed to fasten and convey the workpiece 2 to be dedusted. To this end, the supporting device 20 has a bearing channel profile with a plurality of bearing channels. In this case, the bearing channel profile is designed such that at least half the nozzle elements 14 of the second nozzle unit 13 of the nozzle device 10 are fluidically connected simultaneously to the bearing channels. Furthermore, the supporting device 20 has a stationary table unit 21 and a transport unit 22, which is designed to transport the workpiece 2 to be processed in a main processing direction H. To this end, the transport unit 22 is arranged so as to be movable in the main processing direction H relative to the table unit 21.

The dedusting device 1 illustrated in FIG. 1 also has an ultrasonic device 40. The ultrasonic device 40 is designed to generate an ultrasonic exciter signal for detaching the particles from the narrow side 2a, 2b, 2c, 2d. By means of the ultrasonic exciter signal, the blasting fluid 3 can be excited with a frequency of 16 kHz up to 10 GHz. This has the effect that the narrow sides 2a, 2b, 2c, 2d can be cleaned better of the particles.

Furthermore, the dedusting device 1 has a workpiece detection device 50. With the workpiece detection device 50 it is possible to sense for example the length, width and thickness of a workpiece 2. Furthermore, with the workpiece detection device 50 it is possible to sense a position and location of the workpiece 2 on the supporting device 20. In particular, the workpiece detection device 50 is designed to sense at least one narrow side 2a, 2b, 2c, 2d, that is to say the position and location thereof. Preferably, the workpiece detection device 50 is arranged in a region in which the workpiece enters the dedusting device 1, as is illustrated in FIG. 1. Additionally or alternatively, it may be preferred for the workpiece detection device 50 to be arranged in and/or on the exhaust air device 30.

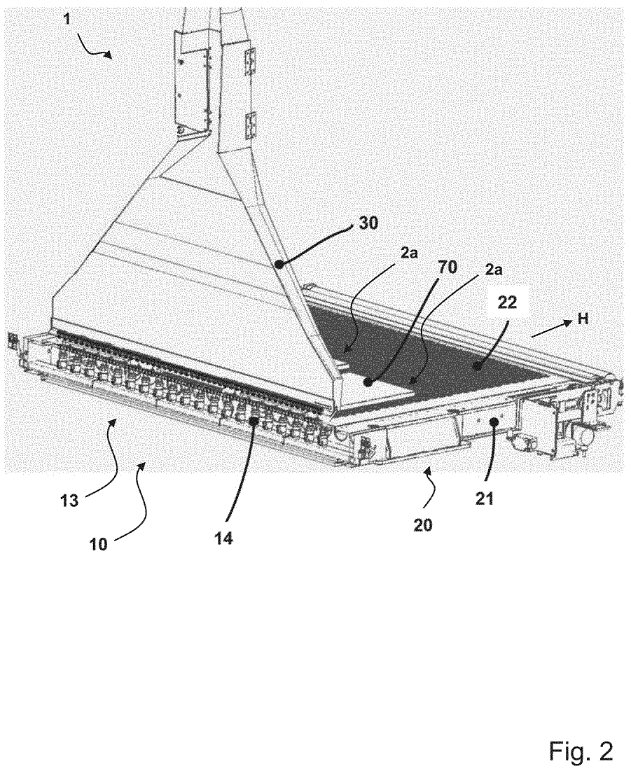

FIG. 2 shows a sectional view of the dedusting device 1 illustrated in FIG. 1. It is clear from the sectional view that the nozzle device 10 has a second nozzle unit 13, which extends orthogonally to the main processing direction H and is arranged releasably on the table unit 21. It may be preferred for the dedusting device 1 to have a further or a plurality of second nozzle units 13. Additionally or alternatively, it may be preferred for the dedusting device 1 to have at least one first nozzle unit 12, which extends parallel to the main processing direction H. The presently releasably arranged second nozzle unit 13 is not arranged so as to be displaceable relative to the supporting device 20 in the preferred embodiment illustrated in the FIGS. 1 and 2. However, for some embodiments of the dedusting device 1, it may be preferred to provide a displaceably arranged first and/or second nozzle unit 12, 13.

The second nozzle unit 13 illustrated in FIG. 2 is arranged on the stationary table unit 21 such that the blasting fluid 3 emerges from the at least one nozzle outlet opening 11 substantially perpendicularly to the supporting device 20. However, it may also be preferred to arrange a nozzle device in such a way that the blasting fluid 3 emerges from the at least one nozzle outlet opening 11 at an angle of between 0° and 90° or 90° and 180° to the supporting device 20.

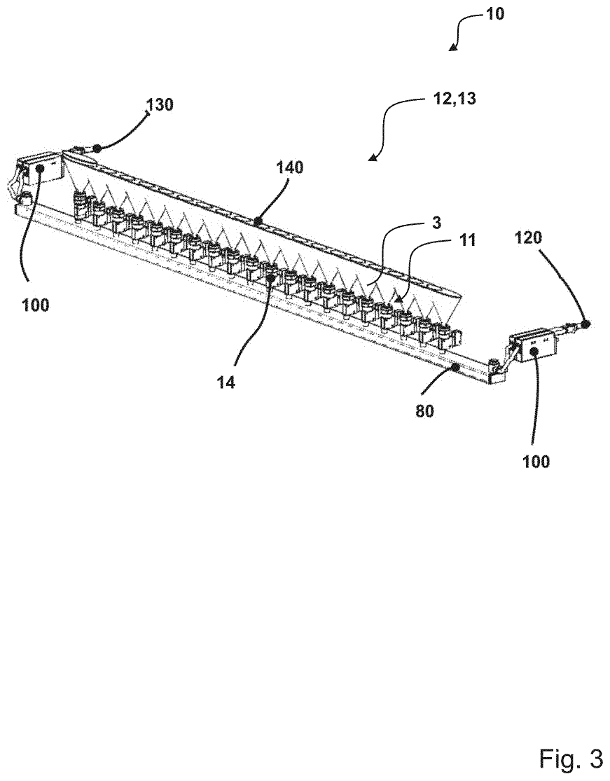

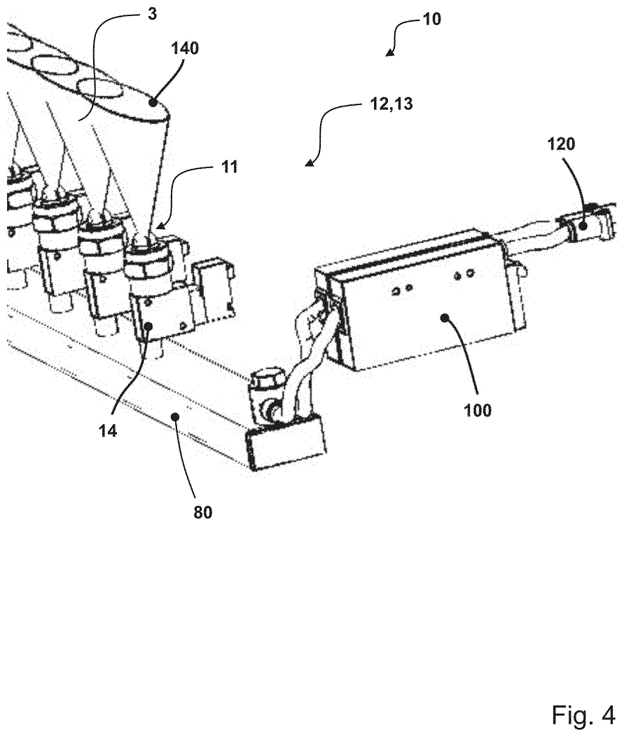

FIG. 3 shows an isometric view of the nozzle device 10 as is visualized by the sectional view illustrated in FIG. 2. FIG. 4 shows a detail view of the embodiment of the nozzle device 10 that is illustrated in FIG. 3.

The nozzle unit, schematically illustrated in FIG. 3, of the nozzle device 10 has both a second and an identical first nozzle unit 12, 13. The nozzle unit has a plurality of nozzle elements 14 that are arranged at a distance from one another in a row and are fluidically coupled to a pressure chamber 80. The pressure chamber 80 is fluidically connected at its ends to an ionizing device 100. The ionizing device 100 is designed to ionize the blasting fluid 3. In the presently preferred embodiment, it may be provided that the blasting fluid 3 is provided in the form of compressed air via a connection element 120 such that, in the operating state, the narrow edges 2a, 2b, 2c, 2d are blasted with ionized compressed air for dedusting.

The embodiment of the dedusting device 1 that is illustrated in FIGS. 1 and 2 may have a nozzle control device (not illustrated) which is connected in signalling terms to the nozzle device 10 and the workpiece detection device 50. By means of the nozzle control device, the nozzle device 10 can be operated in pulsed operation and constant operation. This is possible for example depending on the sensed length, width, thickness and position of the workpiece 2 or depending on the sensed position and location of the narrow edges 2a, 2b, 2c, 2d. The narrow edges classified as side edges 2c, 2d can be blasted with the blasting fluid 3 continuously in constant operation and the front and rear edges 2a, 2b can be blasted with the blasting fluid 3 in a pulsed manner in pulsed operation.

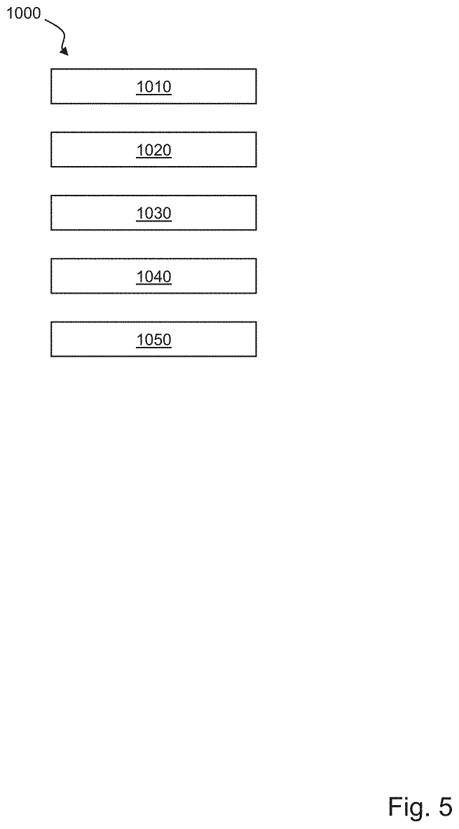

FIG. 5 shows a schematic flow diagram of a preferred embodiment of a method 1000 for dedusting a workpiece 2 with a dedusting device 1, for example with an above-described dedusting device 1.

The method firstly comprises sensing 1010 of a narrow edge 2a, 2b, 2c, 2d of a workpiece 2 to be dedusted and blasting 1020 of the sensed narrow edge 2a, 2b, 2c, 2d with a blasting fluid 3 to remove particles from the sensed narrow edge 2a, 2b, 2c, 2d.

In the presently illustrated preferred embodiment of the method 1000, the step of sensing 1010 a narrow edge 2a, 2b, 2c, 2d of a workpiece 2 to be dedusted comprises a number of sub-steps. In particular, the sensing 1010 of a narrow edge comprises sensing 1010 of a length, a width, a thickness and a position of the workpiece 2 or sensing of a position and/or location of the narrow edge 2a, 2b, 2c, 2d of the workpiece 2. Furthermore, the step of sensing 1010 comprises classifying the sensed narrow edge 2a, 2b, 2c, 2d as a front edge 2a, rear edge 2b and side edge 2c, 2d.

The step of blasting 1020 the sensed narrow edge 2a, 2b, 2c, 2d with a blasting fluid 3 to remove particles from the sensed narrow edge 2a, 2b, 2c, 2d comprises blasting of the sensed narrow edge 2a, 2b, 2c, 2d with the blasting fluid 3 constantly if the sensed narrow edge 2a, 2b, 2c, 2d has been classified as a side edge 2c, 2d and blasting of the sensed narrow edge 2a, 2b, 2c, 2d with the blasting fluid 3 in a pulsed manner or constantly if the sensed narrow edge 2a, 2b, 2c, 2d has been classified as a front edge 2a or rear edge 2b.

The method 1000 also comprises ionizing 1030 the blasting fluid 3 and exciting 1040 the blasting fluid 3 with an ultrasonic device 40 for better dedusting of the narrow edges 2a, 2b, 2c, 2d.

Furthermore, for more efficient and better dedusting of the narrow edges, it is provided to activate 1050 nozzle elements 14 for removing the particles from the narrow edges 2a, 2b, 2c, 2d depending on the sensed length, width, thickness and position of the workpiece 2 or on the sensed position and location of the sensed narrow edge 2a, 2b, 2c, 2d.

### LIST OF REFERENCE SIGNS

1 Dedusting device

2 Workpiece

2a, 2b, 2c, 2d Narrow edge

3 Blasting fluid

10 Nozzle device

11 Nozzle outlet opening

12, 13 First, second nozzle unit

14 Nozzle element

20 Supporting device

21 Stationary table unit

22 Transport unit

30 Exhaust air device

31 Exhaust air inlet opening

40 Ultrasonic device

50 Workpiece detection device

60 Particle charging device

70 Vibration exciter device

80 Pressure chamber

100 Ionizing device

120 Connection element

140 Blasting region

1. A dedusting device for dedusting an edge of a workpiece of particles, comprising:
a nozzle device designed to remove the particles from the edge of the workpiece with a blasting fluid, wherein the nozzle device has at least one nozzle outlet opening through which the blasting fluid emerges from the nozzle device for dedusting in a blasting region;
an exhaust air device designed to extract by suction the particles removed from the edge of the workpiece, wherein the exhaust air device has at least one exhaust air inlet opening through which a composition of the blasting fluid containing particles enters the exhaust air device for dedusting; and
a supporting device on which the workpiece to be dedusted bears in the operating state, wherein the supporting device is arranged between the nozzle device and the exhaust air device.

2. The dedusting device according to claim 1, wherein, in an operating state,
the exhaust air device is arranged above the supporting device and the nozzle device is arranged beneath the supporting device; or
the exhaust air device is arranged beneath the supporting device and the nozzle device is arranged above the supporting device.

3. The dedusting device according to claim 1, wherein the supporting device is designed for fastening and/or conveying the workpiece to be dedusted.

4. The dedusting device according to claim 3, wherein the supporting device
has a stationary table unit, and/or
has a transport unit designed to transport the workpiece to be processed in a main processing direction, wherein

5. The dedusting device according to claim 4 wherein the transport unit is arranged so as to be movable relative to the table unit.

6. The dedusting device according to claim 4 wherein the transport unit is a transport carpet and/or a transport belt and/or has conveyor rollers for transporting the workpiece.

7. The dedusting device according to claim 1 further an ionizing device for ionizing the blasting fluid.

8. The dedusting device according to claim 1 wherein the blasting fluid is compressed air and/or is an ionized blasting fluid and/or is a mixture of a gas and an inert liquid.

9. The dedusting device according to claim 1 further comprising an ultrasonic device designed to generate an ultrasonic exciter signal to detach the particles from the edge of the workpiece.

10. The dedusting device according to claim 9 wherein the ultrasonic device is designed to generate the ultrasonic exciter signal with a frequency of at least 16 kHz and/or at most 10 GHz.

11. The dedusting device according to claim 9 wherein the ultrasonic device is designed to excite the blasting fluid.

12. The dedusting device according to claim 1 further a workpiece detection device, wherein the workpiece detection device is designed
to sense a length and/or width and/or thickness of a workpiece. and/or
to sense a position and/or location of the workpiece on the supporting device, and/or
to sense a position or location of at least one edge of the workpiece.

13. The dedusting device according to claim 1, wherein
the nozzle device has at least one first nozzle unit and/or at least one second nozzle unit, wherein one or more of
the at least first nozzle unit extends parallel to a main processing direction, and/or
the at least second nozzle unit extends orthogonally to the main processing direction, and/or
the at least first and/or second nozzle unit is arrow-shaped, circular, semi-circular and/or half-open, and/or
the at least first and/or second nozzle unit is detachable.

14. The dedusting device according to claim 13 wherein
the at least first and/or second nozzle unit is arranged so as to be displaceable relative to the supporting device, wherein
the at least first and/or second nozzle unit is displaceable depending on
a length and/or a width and/or a thickness and/or a position and/or a location of the workpiece sensed by a workpiece detection device, and/or
a position and/or a location of the at least one edge of the workpiece as sensed by a workpiece detection device.

15. The dedusting device according to claim 13 wherein the at least one first nozzle unit and/or the at least one second nozzle unit has at least one nozzle element, wherein the at least one nozzle element comprises a single nozzle element or a plurality of nozzle elements, and wherein the at least one nozzle element is comprised of the first and second nozzle unit.

16. The dedusting device according to claim 1 wherein the nozzle device comprises at least one first nozzle unit and/or at least one second nozzle unit, wherein the at least on first nozzle unit and/or the at least one second nozzle unit are arranged such that with respect to the supporting device that the blasting fluid emerges from the at least one nozzle outlet opening
substantially perpendicularly to the supporting device, and/or
at an angle of between 0° and 90° or 90° and 180° to the supporting device.

17. The dedusting device according to claim 1, wherein the nozzle device comprises:
a pressure chamber arranged on the supporting device; and/or
a valve device with at least one valve unit which fluidically connects the pressure chamber to at least one first and/or at least one second nozzle unit of the nozzle device.

18. The dedusting device according to claim 1 wherein the supporting device has a bearing channel profile with a plurality of bearing channels, and wherein the nozzle device comprises at least a first nozzle unit and/or at least a second nozzle unit where each of the at least a first nozzle unit and/or the at least a second nozzle element have nozzle elements, and wherein the bearing channel profile of the supporting device is designed such that at least half of the nozzle elements of the at least first nozzle unit and/or the at least a second nozzle unit of the nozzle device are fluidically connected simultaneously to the bearing channels.

19. The dedusting device according to claim 1 further comprising a nozzle control device which is connected in signalling terms to the nozzle device and/or a workpiece detection device,
wherein the nozzle control device is designed
to operate the nozzle device in pulsed operation and/or constant operation, and/or
depending on a sensed length and/or width and/or thickness and/or position of the workpiece
to actuate the nozzle device for pulsed operation and/or constant operation for removing the particles from the edge of the workpiece, and/or
to actuate the nozzle device such that the at least first nozzle unit and/or the at least second nozzle unit is displaced relative to the supporting device.

20. The dedusting device according to claim 1 further comprising an exhaust air device comprising:
a particle charging device designed to electrically charge the particles removed from a blasted edge of the workpiece,
wherein the particle charging device electrically charges particles in accordance with a principle of static charging and/or diffusion charging and/or field charging; and/or
a vibration exciter device designed to detach the particles removed from the blasted edge of the workpiece and then charged particles.

21. A sander comprising a dedusting device according to claim 1.

22. The sander according to claim 21 further comprising at least one sanding unit for processing the workpiece to be dedusted by the dedusting device.

23. A method for dedusting a workpiece with a dedusting device according to claim 1, comprising:
sensing the edge of the workpiece to be dedusted; and
blasting the edge with a blasting fluid to remove particles from a sensed edge.

24. The method according to claim 23,
wherein the step of sensing the edge of the workpiece to be dedusted comprises the following sub-steps:
sensing a length and/or a width and/or a thickness and/or a position of the workpiece, and/or
sensing a position and/or a location of the edge of the workpiece. and/or
classifying a sensed edge as a front edge and/or rear edge and/or a side edge, and/or
classifying the sensed edge as a straight edge and/or a concavely curved edge and/or a convexly curved edge, and/or
wherein the step of blasting the sensed edge with the blasting fluid to remove particles from the sensed edge comprises:
blasting the sensed edge (with the blasting fluid constantly if the sensed edge has been classified as a side edge, (and/or
blasting the sensed edge with the blasting fluid) in a pulsed manner or constantly if the sensed has been classified as a front edge and/or a rear edge, and/or
blasting the sensed edge with the blasting fluid in a pulsed manner or constantly if the sensed edge is concave and/or convex and/or straight and/or circular; and/or
wherein the method further comprises the following steps:
ionizing the blasting fluid, and/or
exciting the particle to be removed by absorption of an ultrasonic exciter signal from an ultrasonic device, and/or
activating nozzle elements to remove the particles from the edges depending on
the sensed length and/or width and/or thickness and/or position of the workpiece; and/or
the sensed position and/or location of the sensed narrow edge.
